(19) United States
(12) Patent Application Publication
(10) Pub. No.: US 2017/0219148 A1
(43) Pub. Date: Aug. 3, 2017

(54) FLOW PASSAGE STRUCTURE

(71) Applicant: Kabushiki Kaisha Kobe Seiko Sho (Kobe Steel, Ltd.), Hyogo (JP)

(72) Inventors: Tomohiro OZONO, Takasago-shi (JP); Akira MATSUOKA, Kobe-shi (JP); Koji NOISHIKI, Takasago-shi (JP)

(73) Assignee: Kabushiki Kaisha Kobe Seiko Sho (Kobe Steel, Ltd.), Hyogo (JP)

(21) Appl. No.: 15/397,121

(22) Filed: Jan. 3, 2017

(30) Foreign Application Priority Data
Feb. 2, 2016 (JP) 2016-017798

(51) Int. Cl. F16L 41/02; B01J 19/24; F28C 3/00

(52) U.S. Cl. CPC F16L 41/02; F28C 3/00; B01J 19/24; B01J 2219/24; B01J 2219/00018

(57) ABSTRACT

The flow passage structure comprises: a plural number of ceramic flow passage layers laminated with one another, inside of which a flow passage is formed; two outermost layers disposed on respective sides of the plural number of flow passage layers in a lamination direction where the flow passage layers are laminated; an outer elastic sheets made of an elastic body, which is interposed between each of the outermost layers and the flow passage layer adjacent thereto; and a fastening member fastening the two outermost layers to each other, in a state that the two outermost layers sandwich the flow passage layers from both sides in the lamination direction.

### FIELD OF THE INVENTION

The present invention relates to a flow passage structure.

### DESCRIPTION OF THE RELATED ART

Conventionally, laminate type flow passage structures formed by laminating layers having a plural number of flow passages arranged therein for flowing fluids have been known. The flow passage structures are used for flowing fluids in each of the flow passages, to generate chemical reaction or other interactions between the fluids during the flowing of the fluid. Japanese Patent No. 5395861 below shows an example of such flow passage structures.

The flow passage structure disclosed in JP 5395861 B comprises a laminated body formed by laminating a plural number of metal substrates which are bound to one another. A plurality of grooves are arranged on one of plate surfaces of the substrates that constitute the laminated body, and an opening of each grooves is sealed with another substrate laminated on said one of the plate surfaces, to thereby form a plurality of flow passages for flowing fluids.

### Problems to be Solved by the Invention

In the flow passage structure disclosed in JP 5395861 B, there is a concern that the metal substrate which constitutes the laminated body may corrode due to a fluid, depending on a condition or a kind of fluid flowing through the flow passage.

An object of the present invention is to provide a flow passage structure capable of preventing corrosion by a fluid flowing through a flow passage.

### Means for Solving the Problem

To accomplish the above object, supposed is a use of a ceramic having the corrosion resistance against a fluid flowing through a flow passage, as a material for the flow passage structure. For example, it may be supposed that a flow passage is formed inside a ceramic flow passage layer, and a plural number of such a flow passage layer are laminated to thereby form a laminate type-flow passage structure. However, it is difficult to bond those flow passage layers to one another to integrate the plural number of laminated ceramic flow passage layers into a flow passage structure, for a factor such as cost. Therefore, it is practical to use a method of fastening those flow passage layers together by a fastening member to integrate the plural number of laminated flow passage layers. However in this case, the fastening may cause bending deformation in a flow passage layer, which leads to damage of a flow passage layer in some cases. Therefore, in order to solve this problem, the present inventor has invented the flow passage structure as follows.

The flow passage structure according to the present invention is a flow passage structure comprising: a flow passage through which a fluid flows; a plural number of ceramic flow passage layers laminated with one another, having the flow passage formed inside; two outermost layers disposed on respective sides of the plural number of the flow passage layers, in a lamination direction where the flow passage layers are laminated; an outer elastic sheet made of an elastic body, which is interposed between each of the outermost layers and the flow passage layer adjacent thereto and; a fastening member that fastens the two outermost layers to each other in a state that the two outermost layers sandwich the flow passage layers from both sides in the lamination direction.

Since this flow passage structure has the outer elastic sheet interposed between each of the outermost layers and the flow passage layer adjacent thereto, even if bending deformation occurs in each of the outermost layers due to fastening by the fastening member, it is possible to absorb the bending deformation of the outermost layer by the outer elastic sheet to prevent the bending deformation from being transmitted to the flow passage layer. As a result, it is possible to prevent the occurrence of damage to the flow passage layer.

In the flow passage structure, the outermost layers preferably have the bending rigidity higher than the bending rigidity of the flow passage layers.

According to this structure, it is possible to reduce bending deformation which may occur in an outermost layer due to fastening by the fastening member. This reduces a possibility that the bending deformation is transmitted from the outermost layer to the flow passage layer, and thus can more surely prevent an occurrence of damage to a flow passage layer.

In the flow passage structure, each of the outermost layers may be a ceramic layer having a flow passage formed inside, and may also be a dummy layer.

In the flow passage structure, preferably: a through-hole is formed in each of the flow passage layers and each of the outermost layers, extends through each of the flow passage layers or each of the outermost layers, and forms a lead-in passage that leads a fluid to the flow passage or a lead-out passage that leads a fluid from the flow passage to the outside of the flow passage structure; and the outer elastic sheet comprises an outer prevention part that surrounds the through hole between each of the outermost layers and each of the flow passage layers adjacent thereto, to prevent the fluid from leaking out though a gap between each of the outermost layers and each of the flow passage layers adjacent thereto.

According to this structure, it is possible to prevent the fluid from leaking out from the lead-in passage or the lead-out passage through the gap between the outermost layer and the flow passage layer adjacent thereto, by the outer prevention part of the outer elastic sheet. Namely, it is possible to prevent the fluid from leaking out through the gap between the outermost layer and the flow passage layer adjacent thereto, by using the outer elastic sheet.

In this case, the flow passage structure preferably further comprises an outer sealing member which is provided along an inner peripheral surface of the outer prevention part, and is sandwiched between each of the outermost layers and each of the flow passage layers adjacent thereto, to seal the gap therebetween.

According to this structure, it is possible to prevent the fluid from leaking out from the lead-in passage or the lead-out passage through the gap between the outermost layer and the flow passage layer adjacent thereto, also by the outer sealing member, in addition to the outer prevention part. Thus, it is possible to more surely prevent the fluid from leaking out from the lead-in passage or the lead-out passage through the gap between the outermost layer and the flow passage layer.

It is preferred that the flow passage structure further comprise an inner elastic sheet made of an elastic body, which is interposed between flow passage layers adjacent to each other in the lamination direction.

According to this structure, even in a case that minute bending deformation occurs in the outermost layer due to fastening by the fastening member, and the bending deformation was not absorbed enough by the outer elastic sheet and transmitted to the flow passage layer, it would be possible to prevent the bending deformation from being transmitted from the flow passage layer to which the bending deformation was transmitted to another flow passage layer adjacent thereto, by the inner elastic sheet, since the inner elastic sheet is interposed between the flow passage layers adjacent to each other. In this manner, it is possible to more surely prevent the occurrence of damage to the flow passage layer.

In this case, preferably, a through-hole is formed in each of the flow passage layers, extends through each of the flow passage layers in the lamination direction, and forms a lead-in passage that leads a fluid to the flow passage or a lead-out passage that leads a fluid from the flow passage to the outside of the flow passage structure; and the inner elastic sheet comprises an inner prevention part that surrounds the through-hole between the flow passage layers adjacent to each other to prevent the fluid from leaking out through a gap between the flow passage layers adjacent to each other.

According to this structure, it is possible to prevent the fluid from leaking out from the lead-in passage or the lead-out passage through the gap between the flow passage layers adjacent to each other, by the inner prevention part of the inner elastic sheet. Namely, it is possible to prevent the fluid from leaking out through the gap between the flow passage layers adjacent to each other, by using the inner elastic sheet.

Further, in this case, the flow passage structure preferably further comprises an inner sealing member which is provided along an inner peripheral surface of the inner prevention part, and is sandwiched between flow passage layers adjacent to each other, to seal the gap therebetween.

In this structure, it is possible to prevent the fluids from leaking out from the lead-in passage or the lead-out passage through the gap between the flow passage layers adjacent to each other, also by the inner sealing member, in addition to the inner prevention part. Thus, it is possible to more surely prevent the fluids from leaking out from the lead-in passage or the lead-out passage through the gap between the flow passage layers adjacent to each other.

In the flow passage structure, preferably, the fastening member comprises a bolt and a nut which is screwed to the bolt; an insertion hole, through which the bolt extends, is formed in each of the outermost layers and each of the flow passage layers; and the bolt extends through the through-hole from one of the two outermost layers, and the nut is screwed and fastened to the bolt on the other of the two outermost layers, to thereby fasten the two outermost layers and the flow passage layers together, in a state that the two outermost layers sandwich the flow passage layers.

According to this structure, since the bolt of the fastening member extends through the insertion hole of each of the outermost layers and the insertion hole each of the flow passage layers, it is possible to relatively position each of the outermost layers and each of the flow passage layers in a direction orthogonal to the lamination direction. Therefore, it is possible to relatively position each of the outermost layers and each of the flow passage layers and fasten them, easily and accurately.

### Effects of the Invention

As described above, according to the present invention, it is possible to provide a flow passage structure capable of preventing corrosion of the flow passage layer due to fluids flowing through the flow passage, and capable of preventing damage to the flow passage layer.

### BRIEF DESCRIPTION OF THE DRAWINGS

FIG. 1 is a perspective view of a flow passage structure according to an embodiment of the present invention.

FIG. 2 is an exploded perspective view of the flow passage structure according to an embodiment of the present invention.

FIG. 3 is a sectional view of a first lead-in passage and a lead-out passage of the flow passage structure and a part in the vicinity thereof, in a direction along the direction in which the first lead-in passage and the lead-out passage are arranged, and at the same time, in a direction perpendicular to plate surfaces of outermost layers and flow passage layers.

FIG. 4 is a sectional view of a second lead-in passage of the flow passage structure and a part in the vicinity thereof, in a direction parallel with the sectional view of FIG. 3.

FIG. 5 is a plan view of a flow passage layer according to an embodiment of the present invention.

### DESCRIPTION OF THE PREFERRED EMBODIMENTS

Hereinbelow, an embodiment of the present invention will be described with reference to the drawings.

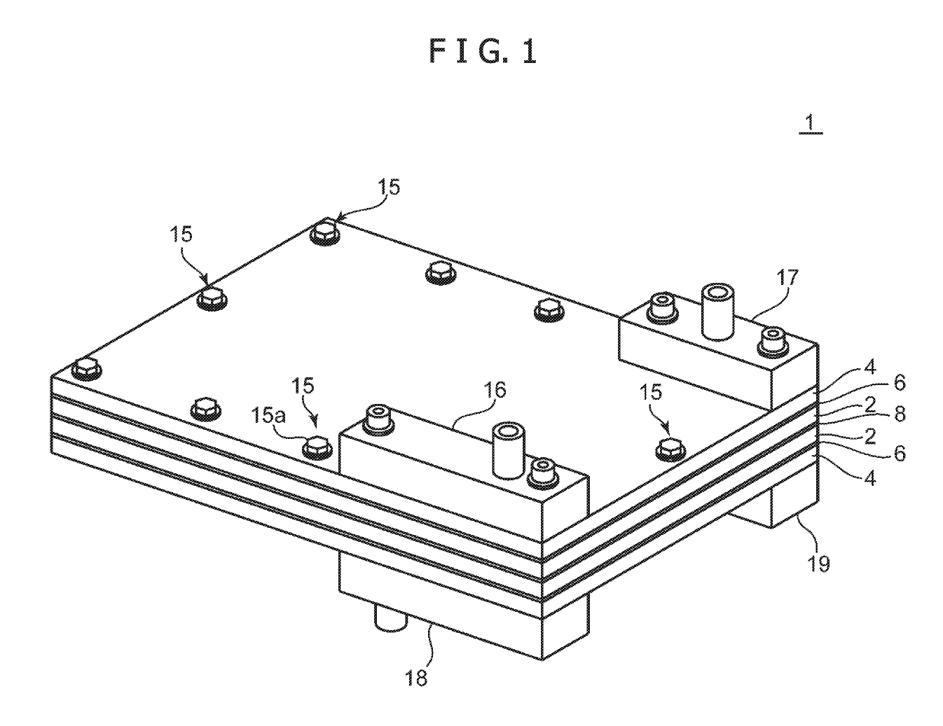

FIG. 1 shows the entire structure of a flow passage structure 1 according to an embodiment of the present invention. The flow passage structure 1 comprises a flow passage 20 for flowing fluids, and configured to generate an interaction between the fluids, such as a mixing, an absorption, a separation, or a chemical reaction, during a process in which the fluids flow through the flow passage 20.

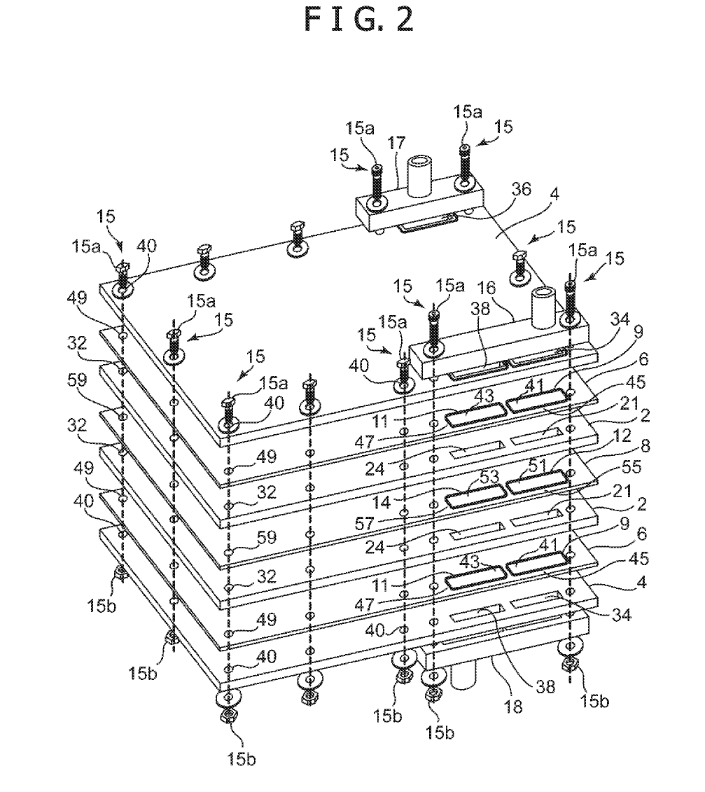

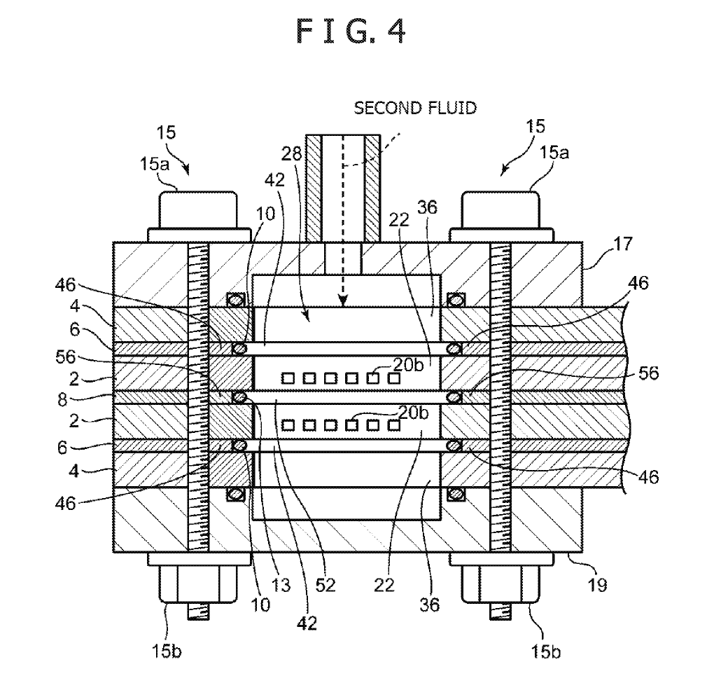

The flow passage structure 1 comprises: a plural number of flow passage layers 2, two outermost layers 4, two outer elastic sheets 6, an inner elastic sheet 8, two pieces of first outer sealing member 9 (see FIG. 2), two pieces of second outer sealing member 10 (see FIG. 4), two pieces of third outer sealing member 11 (see FIG. 2), a first inner sealing member 12 (see FIG. 2), a second inner sealing member 13 (see FIG. 4), a third inner sealing member 14 (see FIG. 2), a plural number of fastening members 15, a first header 16, a second header 17, a third header 18, and a sealing member 19.

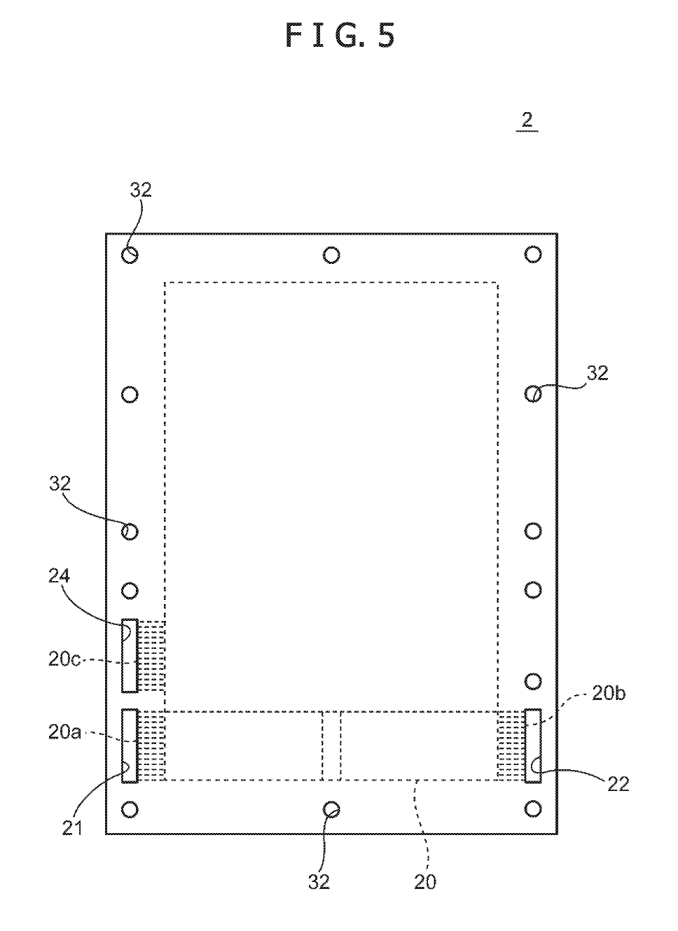

Each of the flow passage layers 2 comprises a flow passage 20 formed inside thereof for flowing fluids (see FIG. 5). Each of the flow passage layers 2 is a ceramic layer and is formed into a shape of plane board, and has a rectangular shape when viewed from the direction perpendicular to the plate surface thereof. A ceramic material for each of the flow passage layers 2 has the corrosion resistance against a fluid flowing through the flow passage 20, and preferably has a non-corrosive ceramic against a fluid. For example, an alumina ceramic is used as a material for each of the flow passage layers 2. A plural number of flow passage layers 2 are laminated with one another, such that the board thickness direction thereof are consistent with one another, and the peripheries thereof are aligned with each other.

FIG. 5 shows a range in which a plural number of flow passages 20 are formed in the flow passage layer 2, with omitting illustration of a specific flow passage shape of each of the flow passages 20. In the present embodiment, the flow passage 20 comprises a first inlet 20a that receives a first fluid, and a second inlet 20b that receives a second fluid, and configured to join the first fluid received from the first inlet 20a and the second fluid received from the second inlet 20b in a midway of the flow passage 20, and to generate an interaction between those fluids. The flow passage 20 also comprises an outlet 20c at an end in the downstream side thereof, and is configured to discharge fluids after flowing through the flow passage 20 and involved in an interaction from the outlet 20c. Incidentally, a shape or a number of the flow passage 20 formed in the flow passage layer 2, or a relative position, etc. of each flow passage 20 in the flow passage layer 2 employed herein are those suitable to a purpose of using the flow passage structure 1, a physical property of a fluid, or a fluid temperature, a flow rate, or any other conditions.

In each of flow passage layers 2, a flow passage layer-first through-hole 21, a flow passage layer-second through-hole 22 and a flow passage layer-third through-hole 24 are formed. Hereinbelow, the flow passage layer-first through-hole 21 is simply referred to as a first through-hole 21, the flow passage layer-second through-hole 22 is simply referred to as a second through-hole 22, and the flow passage layer-third through-hole 24 is simply referred to as a third through-hole 24. The first, the second and the third through-holes 21, 22, and 24 are each an example of a through-hole of the flow passage layer according to the present invention.

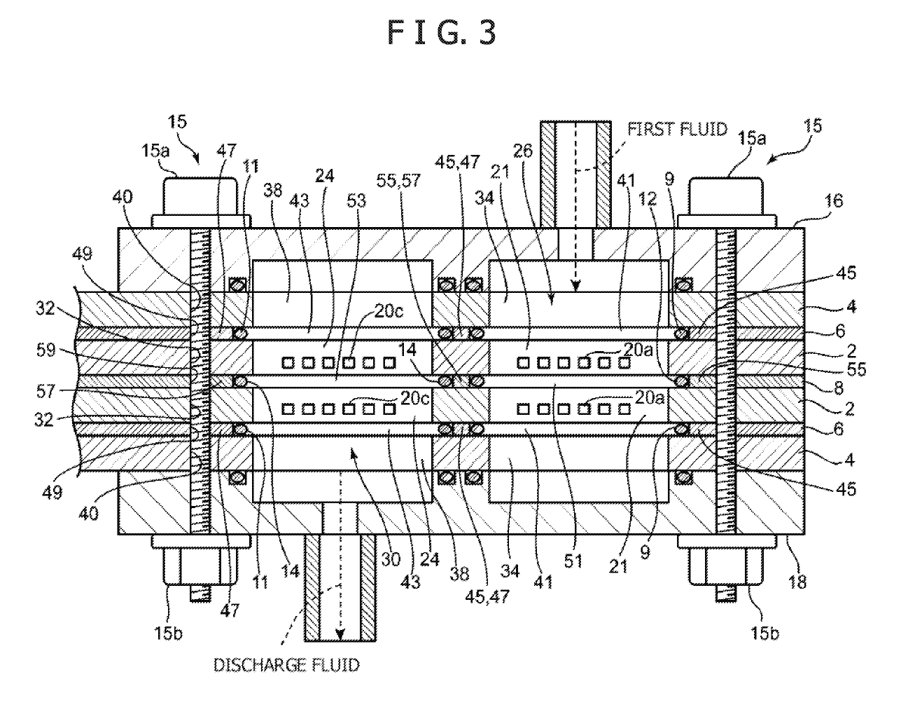

The first through-hole 21 is a hole which extends through the flow passage layer 2 in the direction of lamination, namely, in the thickness direction of the flow passage layers 2, and is a hole which forms a first lead-in passage 26 (see FIG. 3) which leads the first fluid to the first inlet 20a of the flow passage 20. The first lead-in passage 26 is an example of a lead-in passage of the present invention.

The second through-hole 22 is a hole which extends through the flow passage layer 2 in the direction of lamination, namely, in the thickness direction of the flow passage layers 2, and is a hole which forms a second lead-in passage 28 (see FIG. 4) which leads the second fluid to the second inlet 20b of the flow passage 20. The second lead-in passage 28 is an example of a lead-in passage of the present invention.

The third through-hole 24 is a hole which extends through the flow passage layer 2 in the direction of lamination, namely, in the thickness direction of the flow passage layers 2, and is a hole which forms a lead-out passage 30 (see FIG. 3) which leads the fluids discharged from the outlet 20c of the flow passage 20 to the outside of the flow passage structure 1.

The first through-hole 21 and the third through-hole 24 are arranged side by side disposed along one of two long sides of the rectangular flow passage layer 2, and at the same time, disposed closer to one of two short sides of the rectangular flow passage layer 2, as shown in FIG. 5. The second through-hole 22 is disposed in the vicinity of one of two long sides of the flow passage layer 2 on the side opposite to the side where the first through-hole 21 is disposed, and at the same time, in the vicinity of the one of two short sides of the rectangular flow passage layer 2.

Positions of the first through-holes 21 in the flow passage layers 2 are consistent with one another, such that the first through-holes 21 in the flow passage layers 2 completely overlap one another when viewed from the direction of lamination in a state that those flow passage layers 2 are laminated. Positions of the second through-holes 22 in the flow passage layers 2 are consistent with one another, such that the second through-holes 22 in the flow passage layers 2 completely overlap one another when viewed from the direction of lamination in a state that those flow passage layers 2 are laminated. Positions of the third through-holes 24 in the flow passage layers 2 are consistent with one another, such that the third through-holes 24 in the flow passage layers 2 completely overlap one another when viewed from the direction of lamination in a state that those flow passage layers 2 are laminated.

The first inlet 20a of each flow passage 20 is open into the first through-hole 21, as shown in FIG. 3. In this manner, the first inlet 20a communicates with a space in the first through-hole 21. The second inlet 20b of each flow passage 20 is open into the second through-hole 22, as shown in FIG. 4. In this manner, the second inlet 20b communicates with a space in the second through-hole 22. The outlet 20c of each flow passage 20 is open into the third through-hole 24, as shown in FIG. 3. In this manner, the outlet 20c communicates with a space in the third through-hole 24.

In addition, on each of the flow passage layers 2, a plural number of insertion holes 32 (see FIG. 2 and FIG. 5) for a later-described bolt 15a of the fastening member 15 to be inserted through are formed. Specifically, each of the flow passage layers 2 comprises a periphery part which coincides with a periphery part of the outermost layer 4 when viewed from the direction of the lamination of the plural number of flow passage layers 2 and the two outermost layers 4 in the laminated state thereof, and the plural number of insertion holes 32 are formed on this periphery part of each of the flow passage layers 2. Incidentally, a periphery part of each of the flow passage layers 2 represents a part in the vicinity of four sides of the rectangular plate surface of the flow passage layer 2. The plural number of insertion holes 32 is disposed at intervals in a periphery part of each of the flow passage layers 2. Namely, the plural number of insertion holes 32 is disposed at intervals along each of the long sides and each of the short sides of the plate surface of each of the flow passage layers 2. Positions of the plural number of insertion holes 32 in each of the flow passage layers 2 are consistent with one another, such that the insertion holes 32 of the flow passage layers 2 completely overlap one another when viewed from the direction of lamination in a state that the plural number of flow passage layers 2 are laminated.

The two outermost layers 4 are disposed in respective sides of the plural number of flow passage layers 2 in the direction of lamination of the plural number of flow passage layers 2, as shown in FIG. 1. Namely, the two outermost layers 4 sandwich the laminated plural number of flow passage layers 2 from both sides in the direction of the lamination. Each of the outermost layers 4 has the bending rigidity higher than the bending rigidity of the flow passage layers 2. Each of the outermost layers 4 is a dummy layer comprising a solid plane board or block. Each of the outermost layers 4 is made of a ceramic material. As the ceramic material for forming the outermost layers 4, the same ceramic material as the ceramic material for the flow passage layer 2 is used.

Each of the outermost layers 4 is configured in the same manner as the flow passage layers 2, except that no flow passage is formed in the inside thereof. Namely, formed in each of the outermost layers 4 are; an outermost layer-first through-hole 34 (see FIG. 2 and FIG. 3) similar to the first through-hole 21; an outermost layer-second through-hole 36 (see FIG. 2 and FIG. 4) similar to the second through-hole 22; an outermost layer-third through-hole 38 (see FIG. 2 and FIG. 3) similar to the third through-hole 24; and a plural number of insertion holes 40 (see FIG. 2) similar to the plural number of insertion holes 32. Hereinbelow, the outermost layer-first through-hole 34 is simply referred to as a first through hole 34, the outermost layer-second through-hole 36 is simply referred to as a second through hole 36, and the outermost layer-third through-hole 38 is simply referred to as a third through hole 38. The first, the second and the third through-holes 34, 36, and 38 are each an example of a through-hole of an outermost layer of the present invention.

The first through-hole 34 extends through each of the outermost layers 4 at the same position as the position of the first through-hole 21 in the flow passage layer 2, in the outermost layers 4, as shown in FIG. 3. The first through-hole 34, together with the first through-hole 21 of the flow passage layer 2 is configured to form the first lead-in passage 26. Namely, the first through-holes 21 of the flow passage layers 2, the first through-holes 34 of the outermost layers 4, a space between the first through-holes 21 of the flow passage layers 2 adjacent to each other, and spaces between the first through holes 34 of the outermost layers 4 and the first through-holes 21 of the flow passage layers 2 adjacent to the outermost layers 4, are joined together to form the first lead-in passage 26.

The second through-hole 36 extends through the outermost layers 4 at the same position as the position of the second through-hole 22 in the flow passage layer 2, in the outermost layers 4, as shown in FIG. 4. The second through-hole 36, together with the second through-hole 22, is configured to form the second lead-in passage 28. Namely, the second through-holes 22 of the flow passage layers 2, the second through-holes 36 of the outermost layers 4, a space between second through-holes 22 of the flow passage layers 2 adjacent to each other, and spaces between the second through holes 36 of the outermost layers 4 and the second through-holes 22 of the flow passage layers 2 adjacent to the outermost layers 4, are joined together to form the second lead-in passage 28.

The third through-hole 38 extends through the outermost layers 4 at the same position as the position of the third through-hole 24 in the flow passage layer 2, in the outermost layers 4, as shown in FIG. 3. The third through-hole 38, together with the third through-hole 24, is configured to form the lead-out passage 30. Namely, the third through-holes 24 of the flow passage layers 2, the third through-holes 38 of the outermost layers 4, a space between the third through-holes 24 of flow passage layers 2 adjacent to each other, spaces between the third through holes 38 of the outermost layers 4 and the third through-holes 24 of the flow passage layers 2 adjacent to the outermost layers 4, are joined together to form the lead-out passage 30.

A plural number of insertion holes 40 are disposed in the same positions as the positions of the plural number of insertion holes 32 in the flow passage layers 2, in the outermost layers 4, and extend through the outermost layers 4. Namely, the plural number of insertion holes 40 is formed at positions corresponding to the plural number of insertion holes 32 of each of the flow passage layers 2 when viewed from the direction of lamination of the plural number of flow passage layers 2 and the two outermost layers 4, in the periphery parts of the outermost layers 4.

The outer elastic sheets 6 (see FIG. 2) are for absorbing bending deformation, when the bending deformation has occurred in the outermost layer 4, to prevent the bending deformation from being transmitted to the flow passage layer 2. The outer elastic sheets 6 also have a function as a gasket which prevents fluids from leaking out through a gap between the outermost layer 4 and the flow passage layer 2 adjacent thereto.

Each of the outer elastic sheets 6 is interposed between each of the outermost layers 4 and the flow passage layer 2 adjacent thereto, as shown in FIG. 1 and FIG. 3. Specifically, each of the outer elastic sheets 6 is interposed between a periphery part and the entire inside of the periphery part of each of the outermost layers 4 and a periphery part and the entire inside of the periphery part of each of the flow passage layer adjacent thereto. The outer elastic sheet 6 is a sheet made of an elastic body such as a rubber, and having a rectangular shape which is substantially the same shape as the flow passage layer 2 and the outermost layers 4 when viewed from the direction of lamination. The outer elastic sheet 6 has a thickness smaller than a thickness of the flow passage layer 2 or the thickness of the outermost layer 4. On the outer elastic sheet 6, a first opening 41 (see FIG. 2 and FIG. 3), a second opening 42 (see FIG. 4), and a third opening 43 (see FIG. 2 and FIG. 3) are formed.

The first openings 41 are provided in a position which overlaps the first through-holes 21 and 34 when viewed from the direction of lamination in a state that the outer elastic sheets 6 are interposed between the outermost layers 4 and the flow passage layers 2 adjacent thereto. The first openings 41 extends through the outer elastic sheet 6 in the thickness direction thereof, and is configured to be a hole some larger than the first through-hole 21 and 34.

The second openings 42 are provided in a position which overlaps the second through-hole 22 and 36 when viewed from the direction of lamination in a state that the outer elastic sheets 6 are interposed between the outermost layers 4 and the flow passage layers 2 adjacent thereto. The second opening 42 extends through the outer elastic sheet 6 in the thickness direction thereof, and is configured to be a hole some larger than the second through-hole 22 and 36.

The third openings 43 are provided in a position which overlaps the third through-hole 24 and 38 when viewed from the direction of lamination in a state that the outer elastic sheets 6 are interposed between the outermost layers 4 and the flow passage layers 2 adjacent thereto. The third opening 43 extends through the outer elastic sheet 6 in the thickness direction thereof, and is configured to be a hole some larger than the third through-hole 21 or 34.

The outer elastic sheet 6 also comprises a first outer prevention part 45 (see FIG. 2 and FIG. 3), a second outer prevention part 46 (see FIG. 4), and a third outer prevention part 47 (see FIG. 2 and FIG. 3). The first, the second, and the third outer prevention parts 45, 46, and 47 are each an example of an outer prevention part of the present invention.

The first outer prevention part 45 is for preventing the first fluid from leaking out from the first lead-in passage 26 through a gap between the outermost layer 4 and the flow passage layer 2. This first outer prevention part 45 is provided between the outermost layer 4 and the flow passage layer 2 adjacent thereto, and surrounds around the first through-holes 34 and 21, when viewed from the direction of lamination. Namely, the first outer prevention part 45 is a part which surrounds around the first opening 41 of the outer elastic sheets 6.

The second outer prevention part 46 is for preventing the second fluid from leaking out from the second lead-in passage 28 through a gap between the outermost layer 4 and the flow passage layer 2. This second outer prevention part 46 is provided between the outermost layer 4 and the flow passage layer 2 adjacent thereto, and surrounds around the second through-holes 36 and 22, when viewed from the direction of lamination. Namely, the second outer prevention part 46 is a part which surrounds around the second opening 42 of the outer elastic sheet 6.

The third outer prevention part 47 is for preventing fluids discharged from the outlet 20c of the flow passage 20 to the lead-out passage 30 from leaking out through a gap between the outermost layer 4 and the flow passage layer 2. This third outer prevention part 47 is provided between the outermost layer 4 and the flow passage layer 2 adjacent thereto, and surrounds around the third through-holes 38 and 24, when viewed from the direction of lamination. Namely, the third outer prevention part 47 is a part which surrounds around the third opening 43 of the outer elastic sheet 6.

In the outer elastic sheet 6, a plural number of insertion holes 49 (see FIG. 2) are formed. The plural number of insertion holes 49 are provided in positions which coincide with the positions of the plural number of insertion holes 32 of the flow passage layers 2 and the plural number of insertion holes 40 of the outermost layers 4, when viewed from the direction of lamination, in a state that the outer elastic sheets 6 are interposed between the outermost layers 4 and the flow passage layers 2. Each of the insertion holes 49 extends through the outer elastic sheet 6 in the thickness direction thereof.

The inner elastic sheet 8 is for absorbing bending deformation when the bending deformation has occurred in the flow passage layer 2, to prevent the bending deformation from being transmitted from the flow passage layer 2 where the bending deformation has occurred to an adjacent flow passage layer 2. The inner elastic sheet 8 also has a function as a gasket which prevents fluids from leaking out through a gap between the flow passage layers 2 adjacent to each other.

The inner elastic sheet 8 is interposed between the flow passage layers 2 adjacent to each other in the direction of lamination. Specifically, the inner elastic sheet 8 is disposed across an area between periphery parts of the flow passage layers 20 adjacent to each other and an area between the entire areas inside the periphery parts.

The inner elastic sheet 8 is a member similar to the outer elastic sheet 6. On the inner elastic sheet 8, a first opening 51 (see FIG. 2 and FIG. 3), a second opening 52 (see FIG. 4), and a third opening 53 (see FIG. 2 and FIG. 3), similar to the first opening 41, the second opening 42 and the third opening 43 of the outer elastic sheet 6 are formed. The inner elastic sheet 8 also comprises a first inner prevention part 55 (see FIG. 2 and FIG. 3), a second inner prevention part 56 (see FIG. 4), and a third inner prevention part 57 (see FIG. 2 and FIG. 3).

The first opening 51 is interposed in a position which overlaps the first through-hole 21 when viewed from the direction of lamination in a state that the inner elastic sheet 8 is interposed between the flow passage layers 2 adjacent to each other. The second opening 52 is interposed in a position which overlaps the second through-hole 22 when viewed from the direction of lamination in a state that the inner elastic sheet 8 is installed between the flow passage layers 2 adjacent to each other. The third opening 53 is interposed in a position which overlaps the third through-hole 24 when viewed from the direction of lamination in a state that the inner elastic sheet 8 is interposed between the flow passage layers 2 adjacent to each other.

The first inner prevention part 55 is for preventing the first fluid from leaking out from the first lead-in passage 26 through a gap between the flow passage layers 2 adjacent to each other. This first inner prevention part 55 is provided between flow passage layers 2 adjacent to each other, and surrounds around the first through-hole 21, when viewed from the direction of lamination. Namely, the first inner prevention part 55 is a part which surrounds around the first opening 51 of the inner elastic sheet 8.

The second inner prevention part 56 is for preventing the second fluid from leaking out from the second lead-in passage 28 through a gap between flow passage layers 2 adjacent to each other. This second inner prevention part 56 is provided between the flow passage layers 2 adjacent to each other, and surrounds around the second through-hole 22, when viewed from the direction of lamination. Namely, the second inner prevention part 56 is a part which surrounds around the second opening 52 of the inner elastic sheet 8.

The third inner prevention part 57 is for preventing fluids discharged from the outlet 20c of the flow passage 20 to the lead-out passage 30 from leaking out through a gap between the flow passage layers 2 adjacent to each other. This third inner prevention part 57 is provided between the flow passage layers 2 adjacent to each other, and surrounds around the third through-hole 24, when viewed from the direction of lamination. Namely, the third inner prevention part 57 is a part which surrounds around the third opening 53 of the inner elastic sheet 8.

In the inner elastic sheet 8, a plural number of insertion holes 59 similar to the plural number of insertion holes 49 of the outer elastic sheet 6 are formed. The plural number of insertion holes 59 are provided in positions which overlap the positions of the plural number of insertion holes 32 of the flow passage layers 2, the plural number of insertion holes 40 of the outermost layers 4, and the plural number of insertion holes 49 of the outer elastic sheets 6, when viewed from the direction of lamination, in a state that the inner elastic sheet 8 is installed between the flow passage layers 2 adjacent to each other.

The first outer sealing member 9 (see FIG. 2 and FIG. 3) is provided along an inner peripheral surface of the first outer prevention part 45, so as to surround around a space which overlaps the first through-holes 34 and 21 when viewed from the direction of lamination. The first outer sealing member 9 is sandwiched between a periphery part of the first through-hole 34 of the outermost layer 4 and a periphery part of the first through-hole 21 of the flow passage layer 2 to seal the gap therebetween, to thereby prevent the first fluid from leaking out from the first lead-in passage 26 to a gap between the outermost layer 4 and the flow passage layer 2. The first outer sealing member 9 is made of an elastic body such as a rubber, and is formed into a ring shape corresponding to a shape of the first opening 41. As this first outer sealing member 9, what is called O-ring is used. The first outer sealing member 9 is fitted within the first opening 41, and is positioned by being held by the first outer prevention part 45.

The thickness of the first outer sealing member 9 is larger than the thickness of the outer elastic sheet 6, in a state that the first outer sealing member 9 is not sandwiched by the outermost layer 4 and the flow passage layer 2. Then, as a result that the plural number of flow passage layers 2 and the two outermost layers 4 are fastened together, the first outer sealing member 9 is sandwiched between the outermost layer 4 and the flow passage layer 2 and is elastically deformed in a squeezed manner, to have the same thickness as the outer elastic sheet 6, and to closely adhere to the faces of the outermost layer 4 and the flow passage layer 2 opposite to each other.

The second outer sealing member 10, the third outer sealing member 11, the first inner sealing member 12, the second inner sealing member 13, and the third inner sealing member 14, are those similar to the first outer sealing member 9.

Specifically, the second outer sealing member 10 (see FIG. 4) is provided along an inner peripheral surface of the second outer prevention part 46, so as to surround around a space which overlaps the second through-holes 36 and 22 when viewed from the direction of lamination. The second outer sealing member 10 is sandwiched between a periphery part of the second through-hole 36 of the outermost layer 4 and a periphery part of the second through-hole 22 of the flow passage layer 2 to seal the gap therebetween, to thereby prevent the second fluid from leaking out from the second lead-in passage 28 to a gap between the outermost layer 4 and the flow passage layer 2. The second outer sealing member 10 is fitted within the second opening 42, and is positioned by being held by the second outer prevention part 46.

The third outer sealing member 11 (see FIG. 2 and FIG. 3) is provided along an inner peripheral surface of the third outer prevention part 47, so as to surround around a space which overlaps the third through-hole 38 and 24 when viewed from the direction of lamination. The third outer sealing member 11 is sandwiched between a periphery part of the third through-hole 38 of the outermost layer 4 and a periphery part of the third through-hole 24 of the flow passage layer 2 to seal the gap therebetween, to thereby prevent fluids from leaking out from the lead-out passage 30 to a gap between the outermost layer 4 and the flow passage layer 2. The third outer sealing member 11 is set within the third opening 43, and is positioned by being held by the third outer prevention part 47.

The first inner sealing member 12 (see FIG. 2 and FIG. 3) is provided along an inner peripheral surface of the first inner prevention part 55, so as to surround around a space which overlaps the first through-hole 21 when viewed from the direction of lamination. The first inner sealing member 12 is sandwiched between periphery parts of the first through-holes 21 of the flow passage layers 2 adjacent to each other to seal a gap therebetween, to thereby prevent the first fluid from leaking out from the first lead-in passage 26 to the gap between the flow passage layers 2 adjacent to each other. The first inner sealing member 12 is fitted within the first opening 51, and is positioned by being held by the first inner prevention part 55.

The second inner sealing member 13 (see FIG. 4) is provided along an inner peripheral surface of the second inner prevention part 56, so as to surround around a space which overlaps the second through-hole 22 when viewed from the direction of lamination. The second inner sealing member 13 is sandwiched between periphery parts of the second through-holes 22 of the flow passage layers 2 adjacent to each other to seal a gap therebetween, to thereby prevent the second fluid from leaking out from the second lead-in passage 28 to the gap between the flow passage layers 2 adjacent to each other. The second inner sealing member 13 is fitted within the second opening 52, and positioned by being held by the second inner prevention part 56.

The third inner sealing member 14 (see FIG. 2 and FIG. 3) is provided along an inner peripheral surface of the third inner prevention part 57, so as to surround around a space which overlaps the third through-hole 24 when viewed from the direction of lamination. The third inner sealing member 14 is sandwiched between periphery parts of the third through-holes 24 of the flow passage layers 2 adjacent to each other to seal a gap therebetween, to thereby prevent fluids from leaking out from the lead-out passage 30 to the gap between the flow passage layers 2 adjacent to each other. The third inner sealing member 14 is fitted within the third opening 53, and is positioned by being held by the third inner prevention part 57.

The plural number of fastening members 15 (see FIG. 1 and FIG. 2) are for fastening the periphery parts of the two outermost layers 4 and the periphery parts of the plural number of flow passage layers 2, so that the plural number of flow passage layers 2 and the two outermost layers 4, which are laminated in such a state that: the outer elastic sheets 6 and the three sealing members 9 to 11 are interposed between the outermost layers 4 and the flow passage layers 2 adjacent thereto; and the inner elastic sheets 8 and the three sealing members 12 to 14 are interposed between the flow passage layers 2 adjacent to each other, are fastened together in such a manner that the two outermost layers 4 sandwiches the plural number of flow passage layers 2 from the both sides in the direction of lamination.

Specifically, each fastening member 15 comprises a bolt 15a and a nut 15b. The bolt 15a of each fastening member 15 is inserted through the insertion holes 40 of the outermost layers 4, the insertion holes 32 of the flow passage layers 2, the insertion holes 49 of the outer elastic sheets 6, and the insertion holes 59 of the inner elastic sheet 8, from the side of one of the two outermost layers 4, in such a state that the outer elastic sheets 6 are interposed between the outermost layers 4 and the flow passage layers 2 adjacent thereto, and the inner elastic sheet 8 is interposed between the flow passage layers 2 adjacent to each other. The fastening as described above is achieved in such a manner that the nuts 15b corresponding to the bolts 15a is screwed and fastened to the other of the two outermost layers 4, at positions on the side opposite to the above-described one of the outermost layers 4.

The first header 16 (see FIG. 1) is for supplying the first fluid to the first lead-in passage 26 (see FIG. 3), which is mounted on one of the two outermost layers 4. Specifically, the first header 16 is mounted on the one of the outermost layers 4 on its outer face which faces opposite to the adjacent flow passages 2, and covers the first through-hole 34 formed in the one of the outermost layers 4. In this manner, the inner space of the first header 16 communicates with the first lead-in passage 26. A pipeline (not illustrated) is connected to the first header 16, and the first fluid is supplied to the inner space of the first header 16 through the pipeline, and the first fluid is then supplied to the first lead-in passage 26 from the inner space.

The first header 16 also comprises a part which covers the third through-hole 38 that is provided next to the first through-hole 34 in the one of the outermost layers 4, and this part seals an opening of the third through-hole 38. Namely, the part seals an end of the lead-out passage 30 on the side opposite to the third header 18.

The second header 17 (see FIG. 1) is for supplying the second fluid to the second lead-in passage 28 (see FIG. 4). This second header 17 is mounted on the same outer face as the outer face of the one of the outermost layers 4 on which the first header 16 is mounted, and covers the second through-hole 36 formed in the one of the outermost layers 4. In this manner, the inner space of the second header 17 communicates with the second lead-in passage 28. A pipeline (not illustrated) is connected to the second header 17, and the second fluid is supplied to the inner space of the second header 17 through the pipeline, and the second fluid is then supplied to the second lead-in passage 28 from the inner space.

The third header 18 (see FIG. 1) is for discharging a fluid discharged from the outlet 20c of each flow passage 20 to the lead-out passage 30 (see FIG. 3), from the lead-out passage 30 to a discharge pipeline (not illustrated). This third header 18 is mounted on the other of the two outermost layers 4 which is not the one of the two outermost layers 4. Specifically, the third header 18 in mounted on an outer face of the other outer most layer 4 which faces opposite to the flow passage layers 2, and covers the third through-hole 38 formed in the other outermost layer 4. In this manner, the inner space of the third header 18 communicates with the lead-out passage 30. A discharge pipeline (not illustrated) is connected to the third header 18, and the fluid led out from the lead-out passage 30 to the inner space of the third header 18 is discharged through the discharge pipeline.

The third header 18 also comprises a part which covers the first through-hole 34 that is provided next to the third through-hole 38 in the other outermost layer 4, and this part seals an opening of the first through-hole 34. Namely, the part seals the end of the lead-out passage 26 on the side opposite to the first header 16. The third header 18 and the first header 16 are fastened together with the flow passage layers 2, the outermost layers 4, the outer elastic sheets 6, and the inner elastic sheet 8, by the fastening members 15.

The sealing member 19 (see FIG. 1 and FIG. 4) is for sealing an end of the second lead-in passage 28 on the side opposite to the second header 17. The sealing member 19 is mounted on the same outer face as the outer face of the other outermost layer 4 described the above on which the third header 18 is mounted, and covers and seals an opening of the second through-hole 36 formed on the other outermost layer 4. The sealing member 19 and the second header 17 are fastened together with the flow passage layers 2, the outermost layers 4, the outer elastic sheets 6, and the inner elastic sheet 8, by the fastening members 15.

In the present embodiment, it is possible to prevent a flow passage layer 2 from corrosion, namely, the flow passage structure 1 from corrosion, since the flow passage layers 2 are the ceramic layers having the corrosion resistance against a fluid flowing through the flow passage 20 formed inside thereof.

Besides, in the present embodiment, the outer elastic sheet 6 is installed between each of the outermost layers 4 and the flow passage layer 2 adjacent thereto. Therefore, even in a case where bending deformation occurs in each of the outermost layers 4, due to fastening by the fastening member 15, it is possible to absorb the bending deformation of the outermost layer 4 by the outer elastic sheet 6 to prevent the bending deformation from being transmitted to the flow passage layer 2. As a result, it is possible to prevent the occurrence of damage to the flow passage layer 2.

Furthermore, in the present embodiment, each of the outermost layers 4 has the bending rigidity higher than the bending rigidity of the flow passage layers 2, and therefore, it is possible to reduce bending deformation which may occur in each of the outermost layers 4 due to fastening by the fastening member 15.

Specifically, provided that layers constituting a laminate type-flow passage structure are fastened together in balance, at a plurality of points dispersed throughout the periphery parts and the entire area inside the periphery parts, bending deformation is hard to occur in those layers, while in a case that only periphery parts of the layers are fastened together, a fastening force locally acts on the fastened periphery parts of the layers in the direction of lamination, and as a result, large bending deformation easily occurs in those layers. In particular, a flow passage layer having a flow passage formed inside tends to have the low bending rigidity. Therefore, in such a case where the outermost layers on the respective sides of a laminated body constituting a flow passage structure were such flow passage layers, and only the periphery parts of the flow passage layers were fastened together, there would be a concern that a large bending deformation may occur in the flow passage layers, to cause damage to the flow passage layers.

On the other hand, in the present embodiment, the two outermost layers 4 disposed on respective sides in the direction of lamination of the laminated body of the plural number of flow passage layers 2 have the bending rigidity higher than the bending rigidity of the flow passage layers 2. Therefore, even in a case where the periphery parts of the two outermost layers 4 are locally fastened to each other, it is possible to control bending deformation which may occur in the outermost layers 4 to be bending deformation smaller than the bending deformation which would occur in the flow passage layers in a case where only periphery parts of the flow passage layers are locally fastened together. As a result, a possibility that bending deformation is transmitted from the outermost layers 4 to the flow passage layers 2 is reduced, and thus can more surely prevent an occurrence of damage to the flow passage layers.

In addition, in the present embodiment, it is possible to prevent the first fluid from leaking out from the first lead-in passage 26 through a gap between the outermost layer 4 and the flow passage layer 2 adjacent thereto, by the first outer prevention part 45 of the outer elastic sheet 6. It is also possible to prevent the second fluid from leaking out from the second lead-in passage 28 through a gap between the outermost layer 4 and the flow passage layer 2 adjacent thereto, by the second outer prevention part 46 of the outer elastic sheet 6. Further, it is possible to prevent fluids from leaking out from the lead-out passage 30 through a gap between the outermost layer 4 and the flow passage layer 2 adjacent thereto, by the third outer prevention part 47 of the outer elastic sheet 6. Thus, in the present embodiment, it is possible to prevent a leaking out of fluids through a gap between the outermost layer 4 and the flow passage layer 2 adjacent thereto, by using the outer elastic sheet 6.

Besides, in the present embodiment, it is possible to prevent the first fluid from leaking out from the first lead-in passage 26 through a gap between the outermost layer 4 and the flow passage layer 2, also by the first outer sealing member 9 which is provided along an inner peripheral surface of the first outer prevention part 45, in addition to the first outer prevention part 45. It is possible to prevent the second fluid from leaking out from the second lead-in passage 28 through a gap between the outermost layer 4 and the flow passage layer 2, also by the second outer sealing member 10 which is provided along an inner peripheral surface of the second outer prevention part 46, in addition to the second outer prevention part 46. It is possible to prevent fluids from leaking out from the lead-out passage 30 through a gap between the outermost layer 4 and the flow passage layer 2, also by the third outer sealing member 11 which is provided along an inner peripheral surface of the third outer prevention part 47, in addition to the third outer prevention part 47. Thus, it is possible to more surely prevent a leaking out of fluids from the first lead-in passage 26, the second lead-in passage 28, and the lead-out passage 30, through a gap between the outermost layer 4 and the flow passage layer 2.

In addition, in the present embodiment, even if a minute bending deformation occurs in the outermost layer 4 due to fastening by the fastening member 15, and the bending deformation is not absorbed enough by the outer elastic sheet 6 and transmitted to the flow passage layer 2, it would be possible to prevent the bending deformation from being transmitted from the flow passage layer 2 to which the bending deformation was transmitted to another flow passage layer 2 adjacent thereto, by using the inner elastic sheet 8, since the inner elastic sheet 8 is interposed between the flow passage layers adjacent to each other. In this manner, it is possible to more surely prevent an occurrence of damage to the flow passage layer 2.

Besides, in the present embodiment, it is possible to prevent the first fluid from leaking out from the first lead-in passage 26 through a gap between the flow passage layers 2 adjacent to each other, by the first inner prevention part 55 of the outer elastic sheet 8. It is possible to prevent the second fluid from leaking out from the second lead-in passage 28 through a gap between the flow passage layers 2 adjacent to each other, by the second inner prevention part 56 of the outer elastic sheet 8. Further, it is possible to prevent fluids from leaking out from the lead-out passage 30 through a gap between the flow passage layers 2 adjacent to each other, by the third inner prevention part 57 of the outer elastic sheet 8. Thus, it is possible to prevent the fluid from leaking out through a gap between the flow passage layers 2 adjacent to each other, by using the inner elastic sheet 8.

Besides, in the present embodiment, it is possible to prevent the first fluid from leaking out from the first lead-in passage 26 through a gap between the flow passage layers 2 adjacent to each other, also by the first inner sealing member 12 which is provided along an inner peripheral surface of the first inner prevention part 55, in addition to the first inner prevention part 55. It is possible to prevent the second fluid from leaking out from the second lead-in passage 28 through a gap between the flow passage layers 2 adjacent to each other, also by the second inner sealing member 13 which is provided along an inner peripheral surface of the second inner prevention part 56, in addition to the second inner prevention part 56. It is possible to prevent fluids from leaking out from the lead-out passage 30 through a gap between the flow passage layers 2 adjacent to each other, also by the third inner sealing member 14 which is provided along an inner peripheral surface of the third inner prevention part 57 in addition to the third inner prevention part 57. Thus, it is possible to more surely prevent the fluid from leaking out from the first lead-in passage 26, the second lead-in passage 28, and the lead-out passage 30, through a gap between the flow passage layers 2 adjacent to each other.

In the present embodiment, since the bolt 15a of the fastening member 15 extends through the insertion holes 40 of the outermost layers 4, the insertion holes 32 of the flow passage layers 2, the insertion holes 49 of the outer elastic sheets 6, and the insertion hole 59 of the inner elastic sheet 8, it is also possible to relatively position each of the outermost layers 4, each of the flow passage layers 2, each of the outer elastic sheets 6, and the inner elastic sheet 8 in the direction orthogonal to the direction of lamination, by inserting the bolt 15a of the fastening member 15. Therefore, it is possible to relatively position the outermost layers 4, the flow passage layers 2, the outer elastic sheets 6, and the inner elastic sheet 8 and fasten them, easily and accurately.

Incidentally, the flow passage structure according to the present invention is not necessarily limited to the structure as in the embodiment. As a structure of the flow passage structure according to the present invention, for example, the structure as follows may be adopted.

The flow passage structure does not necessarily comprise an inner elastic sheet. Namely, flow passage layers adjacent to each other may be laminated directly on each other.

Further, structure of the outermost layers is not limited to the structure shown in the embodiment. The outermost layers are not necessarily made of a ceramic material, but may be made of a resin, a metal or other materials, as long as the bending rigidity of the outermost layers is made higher than the bending rigidity of the flow passage layers. It is also possible to make the bending rigidity of the outermost layers higher than the bending rigidity of the flow passage layers, by increasing the thickness of the outermost layers.

The periphery parts of the plural number of flow passage layers are not necessarily fastened together. For example, it is also possible that each of the outermost layers is made some larger than the flow passage layers, and the periphery parts of the two outermost layers thus extended to the outside of the periphery parts of the flow passage layers are fastened to each other by a fastening member at positions in the outside of the flow passage layers. In this case, the flow passage layers may not be fastened to one another, but the flow passage layers may be brought in close contact with one another by being sandwiched and pressed by the two outermost layers.

The outer elastic sheet may be interposed at least between a periphery part of an outermost layer and a periphery part of a flow passage layer adjacent thereto, and does not necessarily cover the area inside the periphery part of the flow passage layer.

The flow passage structure may comprise laminated flow passage layers of three or more layers.

The outermost layers and the flow passage layers are not necessarily limited to the layers fastened at the periphery parts. Namely, the outermost layers and the flow passage layers may be fastened together at positions inner than the periphery parts thereof. For example, the outermost layers and the flow passage layers may be fastened together at the center part thereof.

The outermost layer is not limited to a dummy layer, but may be a ceramic layer, inside which a flow passage is formed. Namely, the outermost layer may be the same as the flow passage layer.

The outermost layer is not necessarily limited to the layer having the bending rigidity higher than the bending rigidity of the flow passage layer. Namely, the outermost layer may be a layer those having the bending rigidity equal to or lower than the bending rigidity of the flow passage layer.

In the flow passage structure of the above embodiment, it is possible to interchange the rolls of the leading-in side and the leading-out side, and at the same time, to interchange the rolls of the supply side and the discharge side of the fluids. Namely, it is possible to use the first lead-in passage and the second lead-in passage as a lead-out passage for leading out fluids from the flow passage to the outside of the flow passage structure, and to use the lead-out passage as an lead-in passage for leading fluids into the flow passage. In this case, the first header and the second header may be used for discharging fluids, and the third header may be used for supplying fluids.

What is claimed is:

1. A flow passage structure comprising:
a flow passage through which a fluid flows;
a plural number of ceramic flow passage layers laminated with one another, having the flow passage formed inside;
two outermost layers disposed on respective sides of the plural number of the flow passage layers, in a lamination direction where the flow passage layers are laminated;
an outer elastic sheet made of an elastic body, which is interposed between each of the outermost layers and the flow passage layer adjacent thereto and;
a fastening member that fastens the two outermost layers to each other in a state that the two outermost layers sandwich the flow passage layers from both sides in the lamination direction.

2. The flow passage structure according to claim 1, wherein the outermost layers have the bending rigidity higher than the bending rigidity of the flow passage layers.

3. The flow passage structure according to claim 1, wherein each of the outermost layers is a ceramic layer having a flow passage formed inside.

4. The flow passage structure according to claim 1, wherein each of the outermost layers is a dummy layer.

5. The flow passage structure according to claim 1, wherein:
a through-hole is formed in each of the flow passage layers and each of the outermost layers, extends through each of the flow passage layers or each of the outermost layers, and forms a lead-in passage that leads a fluid to the flow passage or a lead-out passage that leads a fluid from the flow passage to the outside of the flow passage structure; and
the outer elastic sheet comprises an outer prevention part that surrounds the through hole between each of the outermost layers and each of the flow passage layers adjacent thereto, to prevent the fluid from leaking out though a gap between each of the outermost layers and each of the flow passage layers adjacent thereto.

6. The flow passage structure according to claim 5, further comprising an outer sealing member which is provided along an inner peripheral surface of the outer prevention part, and is sandwiched between each of the outermost layers and each of the flow passage layers adjacent thereto, to seal the gap therebetween.

7. The flow passage structure according to claim 1, further comprising an inner elastic sheet made of an elastic body, which is interposed between the flow passage layers adjacent to each other in the lamination direction.

8. The flow passage structure according to claim 7, wherein:
a through-hole is formed in each of the flow passage layers, extends through each of the flow passage layers in the lamination direction, and forms a lead-in passage that leads a fluid to the flow passage or a lead-out passage that leads a fluid from the flow passage to the outside of the flow passage structure; and
the inner elastic sheet comprises an inner prevention part that surrounds the through-hole between the flow passage layers adjacent to each other to prevent the fluid from leaking out through a gap between the flow passage layers adjacent to each other.

9. The flow passage structure according to claim 8, further comprising an inner sealing member which is provided along an inner peripheral surface of the inner prevention part, and is sandwiched between the flow passage layers adjacent to each other, to seal the gap therebetween.

10. The flow passage structure according to claim 1, wherein:
the fastening member comprises a bolt and a nut which is screwed to the bolt;
an insertion hole, through which the bolt extends, is formed in each of the outermost layers and each of the flow passage layers; and
the bolt extends through the through-hole from one of the two outermost layers, and the nut is screwed and fastened to the bolt on the other of the two outermost layers, to thereby fasten the two outermost layers and the flow passage layers together, in a state that the two outermost layers sandwich the flow passage layers.
